(19) United States
(12) Patent Application Publication
(10) Pub. No.: US 2026/0220683 A1
(43) Pub. Date: Jul. 30, 2026

(54) ARTIFICIAL INTELLIGENCE BASED CONTENT SELECTION

(71) Applicant: Maplebear Inc., San Francisco, CA (US)

(72) Inventors: Charles Wesley, San Diego, CA (US); Brent Scheibelhut, Toronto (CA); Naval Shah, Toronto (CA); Madeline Mesard, New York, NY (US); Mark Oberemk, Toronto (CA); Darin Amos, Toronto (CA)

(21) Appl. No.: 19/041,646

(22) Filed: Jan. 30, 2025

(51) Int. Cl. G06Q 30/0601; G06Q 30/0283

(52) U.S. Cl. CPC G06Q 30/0631; G06Q 30/0283; G06Q 30/0643

(57) ABSTRACT

The methods and systems of the present disclosure may: receive data indicating: one or more items to be purchased by a customer from a retailer associated with an online shopping concierge platform, and one or more items purchased by the customer from the retailer; identify one or more items offered by the retailer for subsequent consideration by the customer; determine, based at least in part on one or more machine learning (ML) models, one or more values for each item representing a likelihood that the customer will purchase the item if subsequently presented with the opportunity under specified conditions; generate data describing a graphical user interface (GUI) comprising a ranked listing of at least a portion of the item(s); and communicate the data describing the GUI such that a computing device associated with the customer renders and displays the listing.

### BACKGROUND

Online shopping concierge platforms may link shoppers or pickers with customers, enabling customers to request and receive items located at various remote geographic locations. It will be appreciated that such platforms face technological obstacles in efficiently and effectively simulating the analogous in-person experience, and/or the like. For example, one or more interfaces of a customer computing device (e.g., a touch screen, and/or the like) may only support viewing a limited number of items at a particular time, in a given context, and/or the like.

### SUMMARY

In accordance with one or more aspects of the disclosure, a computer system comprising a processor and a computer-readable medium may receive, via a communication interface and from a computing device associated with a customer of an online shopping concierge platform, data indicating: one or more items to be purchased by the customer from a retailer associated with the online shopping concierge platform, and one or more items purchased by the customer from the retailer. The computer system may identify, based at least in part on the data indicating the item(s) to be purchased by the customer and the item(s) purchased by the customer, one or more items offered by the retailer for subsequent consideration by the customer. The computer system may determine, based at least in part on one or more machine learning (ML) models, and for each item of the item(s) offered by the retailer for subsequent consideration by the customer, one or more values for the item representing a likelihood that the customer will purchase the item if subsequently presented with the opportunity under specified conditions. The computer system may generate data describing a graphical user interface (GUI) comprising a rank listing of the at least a portion of the item(s) offered by the retailer to be subsequently presented to the customer. The computer system may communicate, via the communication interface and to the computing device associated with the customer, the data describing the GUI such that the computing device associated with the customer renders and displays the listing of the at least a portion of the item(s) offered by the retailer.

In accordance with one or more additional aspects of the disclosure, a system may comprise one or more processors and a memory storing instructions that when executed by the processor(s) cause the system to perform operations. The operations may include receiving, from a computing device associated with a customer of an online shopping concierge platform, data indicating: one or more items to be purchased by the customer from a retailer associated with the online shopping concierge platform, and one or more items purchased by the customer from the retailer. The operations may also include identifying, based at least in part on the data indicating the item(s) to be purchased by the customer and the item(s) purchased by the customer, one or more items offered by the retailer for subsequent consideration by the customer. The operations may further include determining, based at least in part on one or more ML models and for each item of the item(s) offered by the retailer for subsequent consideration by the customer, one or more values for the item representing a likelihood that the customer will purchase the item if subsequently presented with the opportunity under specified conditions. The operations may further include generating data describing a GUI comprising a ranked listing of the at least a portion of the item(s) offered by the retailer to be subsequently presented to the customer. The operations may further include communicating, to the computing device associated with the customer, the data describing the GUI such that the computing device associated with the customer renders and displays the listing of the at least a portion of the item(s) offered by the retailer.

In accordance with one or more further aspects of the disclosure, one or more non-transitory computer-readable media may comprise instructions that when executed by one or more computing devices cause the computing device(s) to perform operations. The operations may include receiving, from a computing device associated with a customer of an online shopping concierge platform, data indicating: one or more items to be purchased by the customer from a retailer associated with the online shopping concierge platform, and one or more items purchased by the customer from the retailer. The operations may also include identifying, based at least in part on the data indicating the item(s) to be purchased by the customer and the item(s) purchased by the customer, one or more items offered by the retailer for subsequent consideration by the customer. The operations may further include determining, based at least in part on one or more ML models and for each item of the item(s) offered by the retailer for subsequent consideration by the customer, one or more values for the item representing a likelihood that the customer will purchase the item if subsequently presented with the opportunity under specified conditions. The operations may further include generating data describing a GUI comprising a ranked listing of the at least a portion of the item(s) offered by the retailer to be subsequently presented to the customer. The operations may further include communicating, to the computing device associated with the customer, the data describing the GUI such that the computing device associated with the customer renders and displays the listing of the at least a portion of the item(s) offered by the retailer.

In accordance with aspects of the technology described herein, one or more technological advances may be achieved, produced, and/or the like. For example, it will be appreciated that limitations inherent in a customer's user device may substantially narrow the scope of content they may be provided during a given shopping experience. More intelligently and efficiently selecting relevant content to communicate to a user may not only conserve the user's personal resources but also associated technological resources, e.g., processing power, memory, bandwidth, time, energy, and/or the like.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIGS. 3A, 3B, and 4 illustrate one or more example graphical user interfaces (GUIs), in accordance with one or more embodiments.

FIG. 5 illustrates one or more example methods, in accordance with one or more embodiments.

### DETAILED DESCRIPTION

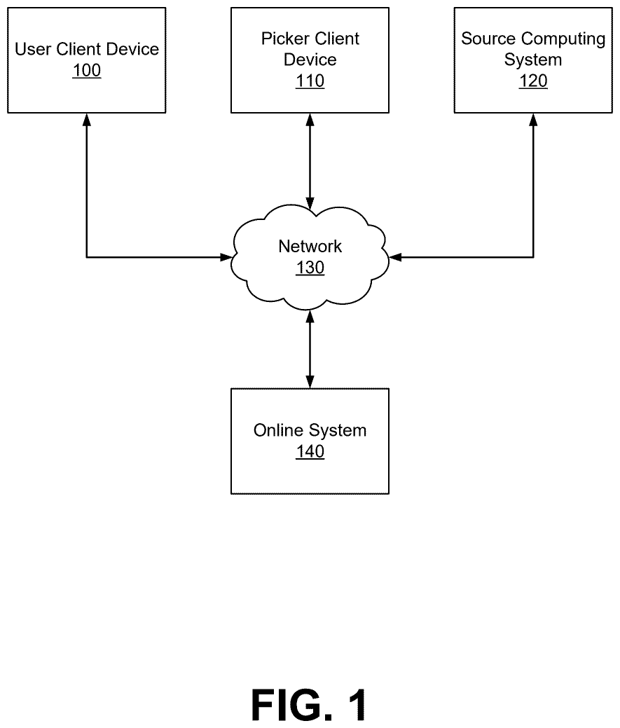

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

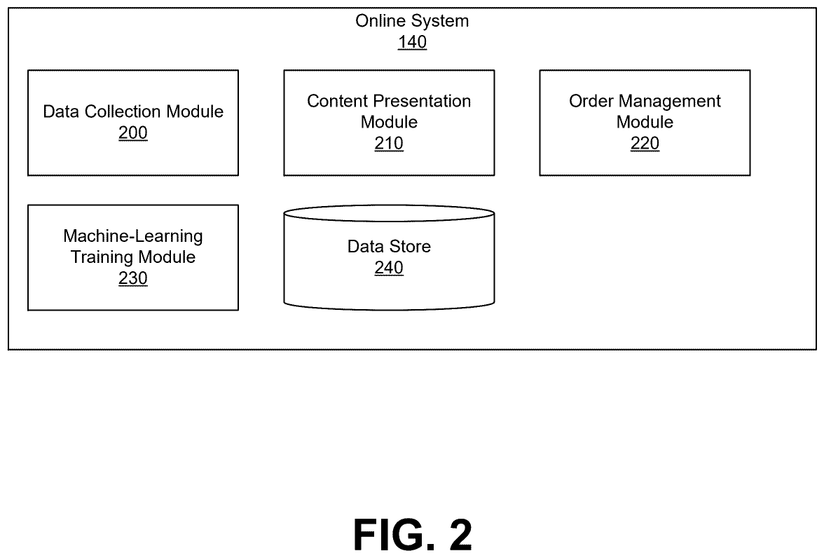

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

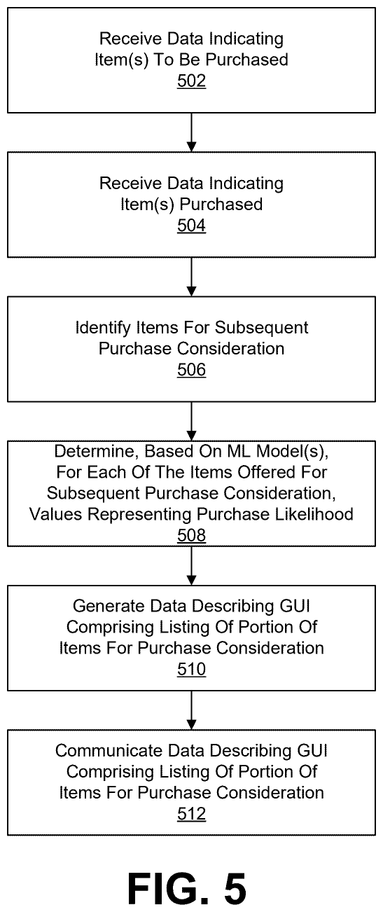

FIG. 5 is a flowchart for a method of artificial intelligence (AI) based content selection, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140, and/or the like). Additionally, each of these steps may be performed automatically by the online system without human intervention.

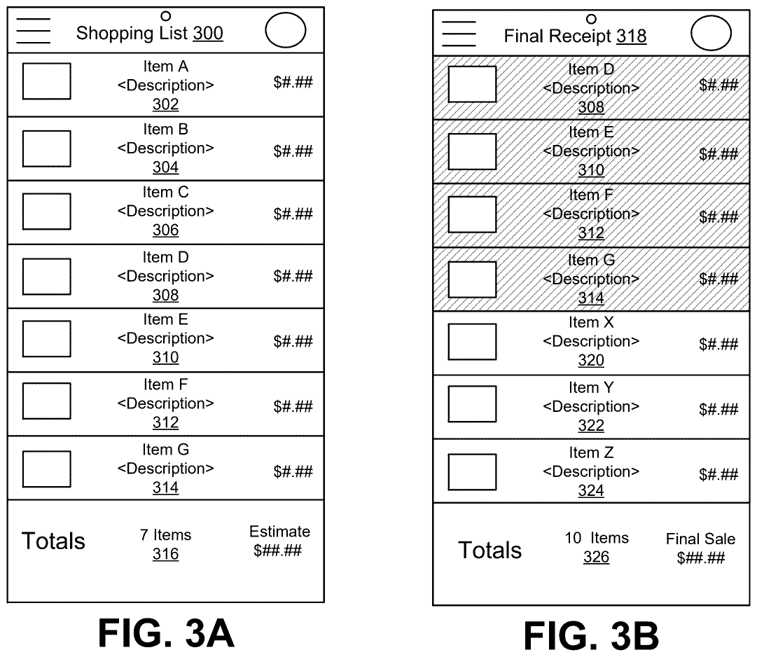

Referring to FIG. 5, at (502), a computer system may receive, from a computing device associated with a customer of an online shopping concierge platform, data indicating one or more items to be purchased by the customer from a retailer associated with the online shopping concierge platform. For example, referring to FIG. 3A, a computer system (e.g., online system 140, and/or the like) may receive (e.g., via network 130, and/or the like), from a computing device associated with a customer (e.g., user client device 100, and/or the like), data indicating one or more items indicated by GUI 300, e.g., items respectively corresponding to elements 302, 304, 306, 308, 310, 312, 314, and/or the like. As illustrated, in some embodiments, GUI 300 may include one or more elements 316 summarizing such item(s), information associated therewith, and/or the like.

Returning to FIG. 5, at (504), the computer system may receive data indicating one or more items purchased by the customer from the retailer. For example, referring to FIG. 3B, the computer system may receive data indicating one or more items indicated by GUI 318, e.g., items respectively corresponding to elements 308, 310, 312, 314, 320, 322, 324, and/or the like. As illustrated, in some embodiments, GUI 318 may include one or more elements 326 summarizing such item(s), information associated therewith, and/or the like.

Returning to FIG. 5, at (506), the computer system may identify, based at least in part on the data indicating the item(s) to be purchased by the customer and the item(s) purchased by the customer, one or more items offered by the retailer for subsequent consideration by the customer. For example, referring to FIG. 3B, the computer system may identify one or more items respectively corresponding to elements 320, 322, 324, and/or the like.

In some embodiments, the computer system may identify the one or more items offered by the retailer for subsequent consideration by the customer by comparing the item(s) to be purchased by the customer with the item(s) purchased by the customer to determine one or more items purchased by the customer that were not among the item(s) to be purchased by the customer (e.g., unplanned purchases, and/or the like). For example, referring to FIG. 3B, the computer system may identify, via such a comparison, the item(s) respectively corresponding to elements 320, 322, 324, and/or the like.

In some embodiments, the computer system may determine that the item(s) purchased by the customer that were not among the item(s) to be purchased by the customer include one or more items associated with a taxonomy node of a product taxonomy offered by the online shopping concierge platform that corresponds to predetermined impulse purchases (e.g., chewing gum, candy, chips, ice cream, periodicals, and/or the like). Additionally or alternatively, the computer system may determine that the item(s) purchased by the customer that were not among the item(s) to be purchased by the customer include one or more items associated with a taxonomy node of a product taxonomy offered by the online shopping concierge platform that corresponds to predetermined staple household items (e.g., eggs, bread, milk, and/or the like).

In some embodiments, the computer system may determine that the item(s) purchased by the customer that were not among the item(s) to be purchased by the customer include one or more items (e.g., sliced bread, and/or the like) associated with a taxonomy node of a product taxonomy offered by the online shopping concierge platform that corresponds to at least one of the item(s) to be purchased by the customer (e.g., bakery, carbohydrates, bread, and/or the like). Additionally or alternatively, the computer system may determine that the item(s) purchased by the customer that were not among the item(s) to be purchased by the customer include one or more items (e.g., bread, deli meat, cheese, condiments, and or the like) that are at least one of a component or an ingredient of at least one of the item(s) to be purchased by the customer (e.g., sandwich ingredients, and/or the like).

Returning to FIG. 5, at (508), the computer system may determine, based at least in part on one or more ML models, and for each item of the item(s) offered by the retailer for subsequent consideration by the customer, one or more values for the item representing a likelihood that the customer will purchase the item if subsequently presented with the opportunity under specified conditions (e.g., in association with one or more related items, at checkout, and/or the like). For example, the computer system may determine one or more such values for each of the item(s) respectively corresponding to elements 320, 322, 324, one or more items associated therewith, and/or the like.

In some embodiments, the computer system may determine, for each item of the item(s) purchased by the customer that were not among the item(s) to be purchased by the customer, a location of the item (e.g., relative to one or more other items purchased by the customer, part of an aisle endcap, checkout exhibit, and or the like), a price of the item relative to one or more historical prices of the item (e.g., whether the item was on sale, discounted, part of a special offer, and/or the like) at the retailer, and/or the like. In some of such embodiments, the value(s) determined by the ML model(s) for the item(s) may be based at least in part on one or more of such determinations, and/or the like.

In some embodiments, the computer system may determine the value(s) for the item(s) based at least in part on a taxonomy node of a product taxonomy offered by the online shopping concierge platform to which the item(s) correspond, one or more brands associated with the item(s), one or more subsequent price(s) for the item(s), one or more subsequent location(s) for the item(s), a number of times the customer has encountered the item(s), and/or the like.

In some embodiments, the item(s) offered by the retailer for subsequent consideration by the customer may include at least one item that is not among the item(s) to be purchased by the customer or the item(s) purchased by the customer (e.g., an item that is novel to the customer, that the customer has not previously encountered, and/or the like).

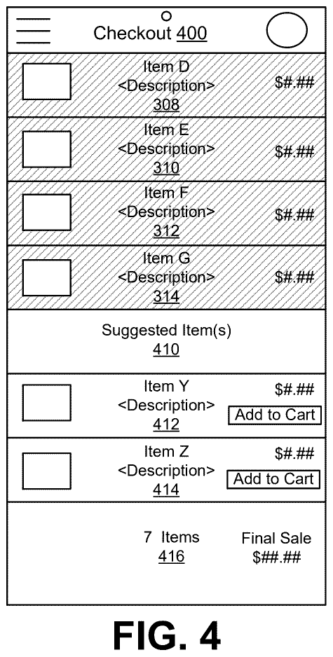

At (510), the computer system may generate data describing a GUI comprising a ranked listing of the at least a portion of the item(s) offered by the retailer to be subsequently presented to the customer. For example, referring to FIG. 4, the computer system may generate data describing GUI 400, and/or the like. As illustrated, GUI 400 may include elements 410 indicating a listing of one or more items for consideration by the customer, e.g., item(s) respectively corresponding to elements 412, 414, and/or the like. As illustrated, in some embodiments, GUI 400 may include one or more elements 416 summarizing such item(s), information associated therewith, and/or the like.

At (512), the computer system may communicate, to the computing device associated with the customer, the data describing the GUI such that the computing device associated with the customer renders and displays the listing of the at least a portion of the item(s) offered by the retailer. For example, the computer system (e.g., online system 140, and/or the like) may communicate (e.g., via network 130, and/or the like) data describing GUI 400 to the computing device associated with the customer (e.g., user client device 100, and/or the like), which may receive the data and render and display GUI 400 based at least in part thereon, and/or the like.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a communication interface of the computer system and from a computing device associated with a customer of an online shopping concierge platform, data indicating: one or more items to be purchased by the customer from a retailer associated with the online shopping concierge platform, and one or more items purchased by the customer from the retailer;
identifying, by the computer system and based at least in part on the data indicating the one or more items to be purchased by the customer and the one or more items purchased by the customer, one or more items offered by the retailer for subsequent consideration by the customer;
generating, by the computer system, using one or more machine learning (ML) models, and for each item of the one or more items offered by the retailer for subsequent consideration by the customer, one or more values for the item representing a likelihood that the customer will purchase the item if subsequently presented with an opportunity under specified conditions;
generating, by the computer system, data describing a graphical user interface (GUI) comprising a ranked listing of the at least a portion of the one or more items offered by the retailer to be subsequently presented to the customer; and
communicating, via the communication interface and to the computing device associated with the customer, the data describing the GUI such that the computing device associated with the customer renders and displays the listing of the at least a portion of the one or more items offered by the retailer.

2. The method of claim 1, wherein identifying the one or more items offered by the retailer for subsequent consideration by the customer comprises comparing the one or more items to be purchased by the customer with the one or more items purchased by the customer to determine one or more items purchased by the customer that were not among the one or more items to be purchased by the customer.

3. The method of claim 2, further comprising:
identifying, by the computer system, that the one or more items purchased by the customer that were not among the one or more items to be purchased by the customer include one or more items associated with a taxonomy node of a product taxonomy offered by the online shopping concierge platform that corresponds to predetermined impulse purchases.

4. The method of claim 2, further comprising:
identifying, by the computer system, that the one or more items purchased by the customer that were not among the one or more items to be purchased by the customer include one or more items associated with a taxonomy node of a product taxonomy offered by the online shopping concierge platform that corresponds to predetermined staple household items.

5. The method of claim 2, further comprising:
identifying, by the computer system, that the one or more items purchased by the customer that were not among the one or more items to be purchased by the customer include one or more items associated with a taxonomy node of a product taxonomy offered by the online shopping concierge platform that corresponds to at least one of the one or more items to be purchased by the customer.

6. The method of claim 2, further comprising:
identifying, by the computer system, that the one or more items purchased by the customer that were not among the one or more items to be purchased by the customer include one or more items that are at least one of: a component or an ingredient of at least one of the one or more items to be purchased by the customer.

7. The method of claim 2, further comprising:
identifying, by the computer system and for each item of the one or more items purchased by the customer that were not among the one or more items to be purchased by the customer, a location of the item.

8. The method of claim 2, further comprising:
determining, by the computer system and for each item of the one or more items purchased by the customer that were not among the one or more items to be purchased by the customer, a price of the item relative to one or more historical prices of the item at the retailer.

9. The method of claim 1, wherein generating the one or more values for the item comprises generating the one or more values for the item based at least in part on a taxonomy node of a product taxonomy offered by the online shopping concierge platform to which the item corresponds.

10. The method of claim 1, wherein generating the one or more values for the item comprises generating the one or more values for the item based at least in part on a brand associated with the item.

11. The method of claim 1, wherein generating the one or more values for the item comprises generating the one or more values for the item based at least in part on a subsequent price of the item.

12. The method of claim 1, wherein generating the one or more values for the item comprises generating the one or more values for the item based at least in part on a subsequent location of the item.

13. The method of claim 1, wherein generating the one or more values for the item comprises generating the one or more values for the item based at least in part on a number of times the customer encountered the item.

14. The method of claim 1, wherein the one or more items offered by the retailer for subsequent consideration by the customer include at least one item that is not among the one or more items to be purchased by the customer or the one or more items purchased by the customer.

15. A system comprising:
one or more processors; and
a memory storing instructions that when executed by the one or more processors cause the system to perform operations comprising:
receiving, from a computing device associated with a customer of an online shopping concierge platform, data indicating: one or more items to be purchased by the customer from a retailer associated with the online shopping concierge platform, and one or more items purchased by the customer from the retailer;
identifying, based at least in part on the data indicating the one or more items to be purchased by the customer and the one or more items purchased by the customer, one or more items offered by the retailer for subsequent consideration by the customer;
generating, by the computer system, using one or more machine learning (ML) models, and for each item of the one or more items offered by the retailer for subsequent consideration by the customer, one or more values for the item representing a likelihood that the customer will purchase the item if subsequently presented with an opportunity under specified conditions;
generating data describing a graphical user interface (GUI) comprising a ranked listing of the at least a portion of the one or more items offered by the retailer to be subsequently presented to the customer; and
communicating, to the computing device associated with the customer, the data describing the GUI such that the computing device associated with the customer renders and displays the listing of the at least a portion of the one or more items offered by the retailer.

16. The system of claim 15, wherein identifying the one or more items offered by the retailer for subsequent consideration by the customer comprises comparing the one or more items to be purchased by the customer with the one or more items purchased by the customer to determine one or more items purchased by the customer that were not among the one or more items to be purchased by the customer.

17. The system of claim 15, wherein the one or more items offered by the retailer for subsequent consideration by the customer include at least one item that is not among the one or more items to be purchased by the customer or the one or more items purchased by the customer.

18. One or more non-transitory computer-readable media comprising instructions that when executed by one or more computing devices cause the one or more computing devices to perform operations comprising:
receiving, from a computing device associated with a customer of an online shopping concierge platform, data indicating: one or more items to be purchased by the customer from a retailer associated with the online shopping concierge platform, and one or more items purchased by the customer from the retailer;
identifying, based at least in part on the data indicating the one or more items to be purchased by the customer and the one or more items purchased by the customer, one or more items offered by the retailer for subsequent consideration by the customer;
generating, using one or more machine learning (ML) models, and for each item of the one or more items offered by the retailer for subsequent consideration by the customer, one or more values for the item representing a likelihood that the customer will purchase the item if subsequently presented with an opportunity under specified conditions;
generating data describing a graphical user interface (GUI) comprising a ranked listing of the at least a portion of the one or more items offered by the retailer to be subsequently presented to the customer; and
communicating, to the computing device associated with the customer, the data describing the GUI such that the computing device associated with the customer renders and displays the listing of the at least a portion of the one or more items offered by the retailer.

19. The one or more non-transitory computer-readable media of claim 18, wherein identifying the one or more items offered by the retailer for subsequent consideration by the customer comprises comparing the one or more items to be purchased by the customer with the one or more items purchased by the customer to determine one or more items purchased by the customer that were not among the one or more items to be purchased by the customer.

20. The one or more non-transitory computer-readable media of claim 18, wherein the one or more items offered by the retailer for subsequent consideration by the customer include at least one item that is not among the one or more items to be purchased by the customer or the one or more items purchased by the customer.
